(19) United States
(12) Patent Application Publication
(10) Pub. No.: US 2015/0180402 A1
(43) Pub. Date: Jun. 25, 2015

(54) METHOD FOR PROTECTING AN ELECTRIC MOTOR FROM OVERLOAD

(71) Applicant: PIERBURG GMBH, NEUSS (DE)

(72) Inventor: Harald Kerkmann, Duesseldorf (DE)

(21) Appl. No.: 14/414,894

(22) PCT Filed: Jun. 11, 2013
(86) PCT No.: PCT/EP2013/061973

§ 371 Date: Jan. 15, 2015

(30) Foreign Application Priority Data
Jul. 17, 2012 (DE) 10 2012 106 410.5

(51) Int. Cl. H02P 29/00

(52) U.S. Cl. CPC H02P 29/0033

(57) ABSTRACT

A method for protecting an electric motor comprising a control unit and configured to drive an actuation device from an overload. The method includes detecting a critical operating state of the electric motor by querying changes of a desired value (Δx), calculating a load value (Load) from a number (Counter_SW) and a magnitude of the changes of the desired value (Δx), sending the load value (Load) calculated to the control unit of the electric motor, and determining the critical operating state if the load value (Load) calculated exceeds a defined maximum allowable load value (LM). A filter is activated so as to limit an adjustment speed if the load value (Load) calculated exceeds the defined maximum permissible load value (LM). The filter is deactivated if the load value (Load) calculated does not exceed the defined maximum allowable load value (LM).

### CROSS REFERENCE TO PRIOR APPLICATIONS

This application is a U.S. National Phase application under 35 U.S.C. §371 of International Application No. PCT/EP2013/061973, filed on Jun. 11, 2013 and which claims benefit to German Patent Application No. 10 2012 106 410.5, filed on Jul. 17, 2012. The International Application was published in German on Jan. 23, 2014 as WO 2014/012712 A2 under PCT Article 21(2).

### FIELD

The present invention relates to a method for protecting an electric motor from overload, the electric motor serving to drive an actuation device, wherein a critical operating state of the electric motor is first deduced and, when a critical operating state is detected, measures are taken to protect the electric motor.

### BACKGROUND

Actuation devices in the field of automobiles are used, for example, to drive flaps and valves, particularly tumble flaps, throttle flaps, exhaust-gas flaps or exhaust-gas return valves. As an actuator of these actuation devices, ever more frequent use is made of an electric motor since such a motor can be controlled in a precise and fast manner. Control of these electric motors is performed either directly via the motor control unit, or the changes of the desired values requested by the motor control unit are passed on to the electric motors via separate control units. The electric motors are subjected to different demands and environments depending on their respective application. A massively high number of load changes or high ambient temperatures may in particular lead to an overload of the electric motors, resulting in damage to the windings and, finally, failure of the functionality of the actuation device.

Various motor protection functions have previously been described to protect such electric motors from overload and overheating.

DE 100 40 080 A1 describes a method for operating an actuation device with a motor protection function wherein a winding temperature of the DC motor is calculated from motor parameters such as the control voltage, the resistance, the ambient temperature and the motor speed, and, if the temperature is expected to be exceeded, the power supply is switched off. Sensors and measuring units are therefore required to realize the protection function.

DE 10 2004 036 134 A1 describes an actuation device which, for protecting an armature winding from thermal overload, delimits a desired motor current value dependant on ambient temperature. An additional sensor and a pre-stored characteristic line are here also required.

A control circuit with overload protection for an electronically commutated electric motor is described in DE 10 2005 025 112 A1. The integrated temperature protection of the final-stage transistors is here utilized to prevent an overload of the armature windings so that, in case of blocking, the power loss is largely transferred into the final-stage transistors. Protection will thus be realized only in case of blocking.

The described approaches suffer from the disadvantage that protection of the engine requires additional sensors. The described protective measure are effective in cases of an existing overload caused, for example, by blocking, whereas they will not prevent the generation of such an overload. A protective function for preventing an overload during normal operation has not previously been described.

### SUMMARY

An aspect of the present invention is to provide a method for protecting an electric motor from an overload caused by the normal driving of the electric motor so that, for example, an overheating of the windings is avoided. An alternative aspect of the present invention is to omit additional sensors and the like.

In an embodiment, the present invention provides a method for protecting an electric motor comprising a control unit and configured to drive an actuation device from an overload. The method includes detecting a critical operating state of the electric motor by querying changes of a desired value (Δx), calculating a load value (Load) from a number (Counter_SW) and a magnitude of the changes of the desired value (Δx), sending the load value (Load) calculated to the control unit of the electric motor, and determining the critical operating state if the load value (Load) calculated exceeds a defined maximum allowable load value (LM). A filter is activated so as to limit an adjustment speed if the load value (Load) calculated exceeds the defined maximum permissible load value (LM). The filter is deactivated if the load value (Load) calculated does not exceed the defined maximum allowable load value (LM).

### BRIEF DESCRIPTION OF THE DRAWING

The present invention is described in greater detail below on the basis of embodiments and of the drawings in which

FIG. 1 shows an embodiment of a method according to the present invention as represented in a schematic flow diagram.

### DETAILED DESCRIPTION

If a load value calculated from the number and the magnitude of the changes of the desired value sent to a control unit of the electric motor exceeds a defined maximum allowable load value, a critical operating state will correspondingly be deduced and, thereafter, as a measure to protect the electric motor if the maximum permissible load value is exceeded, a filtering is activated to limit the adjustment speed. The adjusting will thereby be slowed down so that, in the case of frequent changes of the desired values, an overheating of the electric motor is avoided.

In an embodiment of the present invention, the operating state can, for example, be deduced only if the load value calculated from the number and the magnitude of the changes of the desired value sent to the control unit of the electric motor exceeds the defined maximum permissible load value (LM) for a period of time depending on the previous load conditions. This prevents the motor protection function from already being activated in a short time period so as to avoid damaging the electric motor, while the function is activated only in cases where an overload extends for a time period which in fact causes a distinct rise of the windings' temperature.

can be advantageous if, as a load value, there is used the product of a value which is dependent on the number of changes of the desired value in a defined time interval and the sum of the changes of the magnitude in the time interval. Consideration is thus given both to the magnitude of the changes of the desired value and of their number during detection since an overload may be caused both by too large changes of the adjustment path and by small changes of the desired value occurring too rapid in succession.

In an embodiment of the present invention, the calculation of the product can, for example, be performed under inclusion, in a quadratic or a cubic manner, of the number of the changes of the desired value in the defined time interval, thus giving consideration to the fact that a high frequency of changes of the desired value will lead to a faster overload of the electric motor.

In an embodiment of the present invention, a change of the desired value can, for example, be considered as a change of the desired value in the calculation only when a limiting value is exceeded. Interference peaks are thereby filtered out.

In an embodiment of the present invention, the query of the changes of the desired value can, for example, be performed with a predetermined clock frequency because angular changes will normally not occur in shorter intervals. The clock frequency is thereby to be selected to be about 10 ms in correspondence thereto. Usual drives have a mass inertia to the effect that changes of the desired values are executed only with a delay so that a query with a correctly set clock frequency will be sufficient.

In an embodiment of the method of the present invention, the calculation of the load value can, for example, be performed with a frequency corresponding to a multiple of the clock frequency for the query of the changes of the desired value. It is thereby safeguarded that a representative evaluation of the changes of the desired value is possible, wherein the frequency must be selected so that, in this time period, no overload is possible which could damage the motor. A clock of 1 second could be generated as a normal value.

The filtering will be again switched off if the load value falls below the maximum allowable load value in order to nonetheless safeguard, if possible, a fast adjustment via the drive during phases without overload.

It can be advantageous if the filter is switched off only if the load value falls below the maximum allowable load value for a time period depending on the preceding load conditions. It is thereby realized that, in the case of several relatively short preceding overloads of the actuation device, a new overload occurring after short normal operation can be more quickly deduced. Residual heat in the actuation device is thus considered.

In an embodiment of the present invention, to deduce that the time periods depending on the preceding load conditions for switching-on or switching-off the filter are exceeded, use can, for example, be made of a counter which operates to increase the count when the maximum allowable load value is exceeded and to reduce the count when the maximum allowable load value is fallen below, wherein, when a defined maximum count is reached, the filter is switched on, and, when a count of 0 is reached, the filter is switched off. The temporal intervals and the duration of occurring overloads and normal loads are thereby reasonably included in the procedure.

It can thereby be advantageous if the counter operates to increase the count by a multiple faster than decreasing it. The fact is thereby considered that the windings heat-up faster than they cool-down. A normal factor would be a factor of three (3).

In an embodiment of the present invention, a filter in the form of a PT₂ filter has, for example, been found in tests to avoid overloads.

A method for protecting an electric motor from overload is thereby provided which is above all suited to reliably filter out overloads occurring during operation without the need to interrupt the actual operation of the actuation device. The positions to be controlled in the process, for example, those of a flap, will be achieved to a sufficient extent, Overload caused by frequent changes of the desired value with resultant damage to the electric motor is thus avoided without the necessity of using additional temperature sensors or the like.

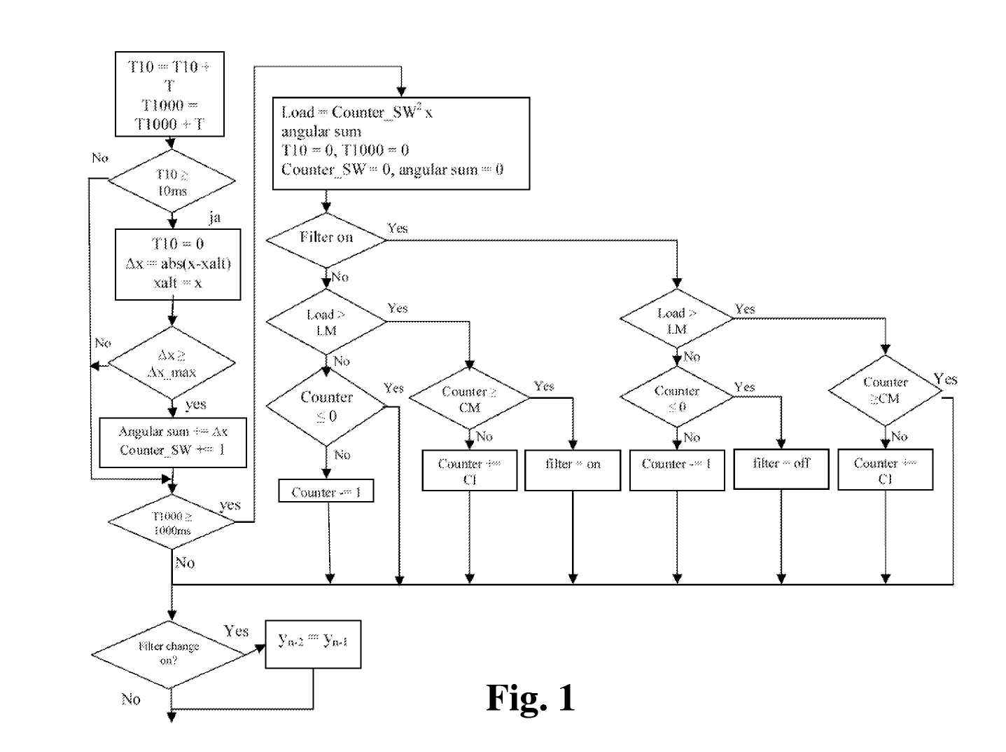

An embodiment of a method according to the present invention is represented in the FIG. 1 as a schematic flow diagram and will be described hereunder.

The method of the present invention is started each time by setting the clock frequencies. For example, in case of a clock of 2 ms (T), there are generated a clock frequency of 10 ms (T10) for query of the change of the desired value and a clock frequency of 1 second (T1000) for calculation of a load value. If 10 ms (T10) has not elapsed after the last query, a next query is performed as to whether the clock frequency of 1 second (T1000) has passed. If the answer is “no”, nothing is performed, and the clock will continue to run. If the 10 ms (T10) are over, the amount of the difference between the previous desired value (xalt) and the current desired value (x) is calculated and the current desired value (x) is set to (xalt). In case the calculated change of the desired value (Δx) should fall under a predetermined limiting value (Δx_max), the value (Δx) will not be considered and the process will continue with the next query. If the change of the desired value exceeds the limiting value (Δx_max), this change of the desired value (Δx) will be added to the already stored changes of the desired value, thus generating an angular sum. A counter will further be increased by 1, i.e., there will be counted the number (Counter_SW) of the changes of the desired value (Δx).

This sequence will now be repeated every 10 ms (T10) until a time of one second (T11000) has lapsed, i.e., the clock frequency for query of the load value has been reached. During this time period, the number (Counter_SW) and the magnitude (Δx) of the changes of the desired value are thus added up.

After lapse of the clock frequency of 1 second (T1000), a load value (Load) will be calculated from the product of the square of the number of changes of the desired value and the sum of the magnitudes of the changes of the desired value (angular sum). At the same time, the clock frequencies (T10, T1000) as well as the number of the angular changes (Counter_SW) and the sum of the magnitudes of the changes of the desired value (angular sum) will be set to 0 again. It is accordingly considered that the number of changes of the desired value has a more damaging influence on the winding temperature than the magnitude of the changes of the desired value.

A query is subsequently performed as to whether a filter has already been switched on. If this filter has not yet been switched on, it will first be examined whether the calculated load value (Load) exceeds a defined maximum allowable load value (LM) which, beforehand, must be detected by tests and must be set. If this maximum allowable load value (LM) is not exceeded, it will then be examined whether a counter (Counter) is larger than 0 or smaller than and respectively equal to 0. If this counter is larger than 0, it will be decreased by 1, and the process will be continued without further changes. If the counter is already equal to or smaller than 0, the process will be continued without changing the counter. In this case, no overload exists.

If, however, the comparison between the load value (Load) and the maximum allowable load value (LM) has the result that the load is too large, it is further examined whether the counter (Counter) exceeds a maximum allowable counter value (CM). If this is not the case, the counter will be increased by a value (CI) corresponding, for example, to the value of 3, so that, in case the load is exceeded, the counter will count up at three times the speed as compared to when counting down in case the maximum load is not exceeded. If the maximum allowable counter value (CM) is in fact exceeded, the filter, which preferably is a PT₂ filter, will be switched on, with the consequence that the adjustment speed of the actuation device will be distinctly reduced.

If the result of the query whether the filter has already been switched on, is “yes”, the load value (Load) will again be compared to the maximum allowable load value (LM). case the load value (Load) again exceeds the maximum allowable load value (LM) and the counter (Counter) exceeds the maximum allowable counter value (CM), the filter will remain switched on and no further change will be made. However, in case the counter (Counter) has not yet exceeded the maximum allowable counter value (LC), the counter (Counter) will again be increased by 3 (CI). This query serves the purpose that the counter (Counter), after previously briefly falling under the maximum allowable counter value (CM) that did not yet cause the filter to be switched off, will be newly increased if again exceeding the value, in order to prevent a too early switch-off of the filter.

Conversely, if the filter is in the switched-on state and the maximum allowable load value (LM) is not exceeded, the counter (Counter) will be decreased by 1 unless it did not already reach the value 0. If the filter has already reached the value 0, the filter will again be switched off.

The described method thus has the effect that the actuation device will each time be checked with respect to its load condition. If this load condition is too extreme over a predetermined period of time, the adjustment speed of the electric motor will be decreased via the PT₂ filter. Also, if this load value not exceeded, this will only cause the filter to be switched off after a delay and will thus result in a normal operation of the actuation device. In case of frequent changes between a state where the load is exceeded and a state where the load is not exceeded, these states will be weighted via the respective count value of the counter so that, by previous tests, this weighting can be optimally attuned to real changes of the winding temperature.

Overloads of an actuation device and resultant damage to the windings caused by too frequent changes of the desired value that are supplied to the electric motor, such as by a motor control device, will consequently be avoided. In correspondence thereto, such an actuation device can be adapted for a large variety of motor control devices with different clock frequencies by way of a corresponding adaptation of the query and maximum values without the need to use other electric motors.

It should be evident that, in each case, an adaptation of the predefined threshold values and query frequencies will be required. The scope of protection of the present main claim is further not restricted to the method as described herein. It can thus be envisioned to omit various delaying queries or to adopt a different weighting of the number and the magnitude of the load values.

The present invention is not limited to embodiments described herein; reference should be had to the appended claims.

What is claimed is:

1-12. (canceled)

13. A method for protecting an electric motor from an overload, the electric motor comprising a control unit and configured to drive an actuation device, the method comprising:
detecting a critical operating state of the electric motor by:
querying changes of a desired value (Δx),
calculating a load value (Load) from a number (Counter_SW) and a magnitude of the changes of the desired value (Δx),
sending the load value (Load) calculated to the control unit of the electric motor, and
determining the critical operating state if the load value (Load) calculated exceeds a defined maximum allowable load value (LM); and either
activating a filter so as to limit an adjustment speed if the load value (Load) calculated exceeds the defined maximum permissible load value (LM), or
deactivating the filter if the load value (Load) calculated does not exceed the defined maximum allowable load value (LM).

14. The method as recited in claim 13, wherein the critical operating state is determined only if the load value (Load) exceeds the defined maximum permissible load value (LM) for a time period dependent on preceding load conditions.

15. The method as recited in claim 13, wherein the calculation of the load value (Load) is a product of a value dependent on:
the number (Counter_SW) of the changes of the desired value (Δx) in a defined time interval (T1000), and
a sum (angular sum) of the magnitude of the changes of the desired value (Δx) in the defined time interval (T1000) time interval.

16. The method as recited in claim 15, wherein the calculation of the product is performed under inclusion, in a quadratic manner or a cubic manner, of the number (Counter_SW) of the changes of the desired value (Δx) in the defined time interval (T1000).

17. The method as recited in claim 13, wherein changes of the desired value (Δx) are considered in the calculation of the load value (Load) only when a limiting value (Δ_xmax) is exceeded.

18. The method as recited in claim 13, wherein the querying of the changes of the desired value (Δx) is performed with a predetermined clock frequency (T10).

19. The method as recited in claim 18, wherein the calculation of the load value (Load) is performed with a frequency (T1000) corresponding to a multiple of the predetermined clock frequency (T10) for the querying of the changes of the desired value (Δx).

20. The method as recited in claim 13, wherein the deactivating of the filter is performed only if it is determined the load value (Load) calculated does not exceed the defined maximum allowable load value (LM) for a time period dependent on preceding load conditions.

21. The method as recited in claim 20, wherein, when determining whether the time period dependent on preceding load conditions for activating or deactivating the filter is exceeded/not exceeded, the method further comprises:
providing a counter which increases the count (Counter) when the defined maximum allowable load value (LM) is exceeded, and which reduces the count (Counter) when the maximum allowable load value (LM) is not exceeded, so that the filter is activated when a defined maximum count (Counter) is reached, and the filter is deactivated when a count of 0 is reached.

22. The method as recited in claim 21, wherein the counter increases the count (Counter) by a multiple which is higher than when decreasing the count (Counter).

23. The method as recited in claim 13, wherein the filter is a PT₂ filter.
